(19) United States
(12) Patent Application Publication
(10) Pub. No.: US 2026/0180792 A1
(43) Pub. Date: Jun. 25, 2026

(54) UNIFIED KEY MANAGEMENT IN A COMMUNICATION NETWORK ENVIRONMENT

(71) Applicant: Nokia Technologies Oy, Espoo (FI)

(72) Inventors: Saurabh KHARE, Bangalore (IN); Ranganathan MAVUREDDI DHANASEKARAN, Munich (DE); Suresh P NAIR, Estero, FL (US)

(21) Appl. No.: 19/413,757

(22) Filed: Dec. 9, 2025

Related U.S. Application Data
(60) Provisional application No. 63/737,023, filed on Dec. 20, 2024.

(51) Int. Cl. H04L 9/08

(52) U.S. Cl. CPC H04L 9/0861

(57) ABSTRACT

Unified key generation management in a communication network environment are disclosed. By way of one example, a method in user equipment generates a first cryptographic value, independent of generation of the same first cryptographic value at a first network entity of a first communication network, wherein the first network entity includes an access control and mobility function and the first cryptographic value is derived from a cryptographic value for a security anchor function. The method generates a set of one or more user plane cryptographic values from the first cryptographic value, independent of the generation of the same set of one or more user plane cryptographic values at the first network entity. The method uses the set of one or more user plane cryptographic values to securely communicate with a second network entity of the first communication network, wherein the second network entity includes an access user plane function.

### FIELD

The field relates generally to communication networks, and more particularly, but not exclusively, to security management in such communication networks.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

Advancements in communication network technologies have rapidly progressed over recent years.

Fourth generation (4G) wireless mobile telecommunications technology, also known as Long Term Evolution (LTE) technology, provided high-capacity mobile multimedia with high data rates particularly for human interaction, as compared with previous generations of communication networks.

Fifth generation (5G) technology currently provides not only for human interaction use cases, but also for machine type communications in so-called Internet of Things (IoT) networks. While 5G networks enable massive IoT services (e.g., very large numbers of limited capacity devices) and mission-critical IoT services (e.g., requiring high reliability), improvements over 4G communication services are supported in the form of enhanced mobile broadband (eMBB) services providing improved wireless Internet access for mobile devices.

Sixth generation (6G) technology is now being developed for communication networks that differs from 5G technology by offering, inter alia, significant improvements in speed and latency (e.g., the Ultra-Reliable Low-Latency Communication (URLLC) service that began with 5G is being refined and improved in 6G to address more stringent connectivity requirements), as well as the capability to sense a physical environment through expanded spectrum band usage. Such sensing capability enables creation of a digital twin of the physical environment which leads to new applications such as, but not limited to, highly accurate localization and immersive experiences.

However, security management is an important consideration in any communication network environment—and now especially ones that provide for applications such as localization, immersion, and the like. Moreover, security management is an ongoing consideration due to continuing attempts to improve the architectures and protocols associated with communication networks in order to increase network efficiency and/or subscriber convenience. Accordingly, security management can present significant technical challenges.

### SUMMARY

Illustrative embodiments provide techniques for unified key management in a communication network environment.

In one illustrative embodiment, a method generates a first cryptographic value, independent of a generation of the same first cryptographic value at a first network entity of a first communication network, wherein the first network entity includes an access control and mobility function and the first cryptographic value is derived from a cryptographic value for a security anchor function. The method generates a set of one or more user plane cryptographic values from the first cryptographic value, independent of the generation of the same set of one or more user plane cryptographic values at the first network entity. The method then uses the set of one or more user plane cryptographic values to securely communicate with a second network entity of the first communication network, wherein the second network entity includes an access user plane function. In another embodiment, the set of one or more user plane cryptographic values can alternatively be generated using a second cryptographic value for the access user plane function.

In another illustrative embodiment, a method generates, at user equipment, a set of one or more user plane keys independent of an access control and mobility function associated with a serving network to which the user equipment is connected. The method, at the user equipment, using the set of one or more user plane keys, establishes a secure communication channel with an access user plane function of the serving network absent an access network security context.

Further illustrative embodiments are provided in the form of a non-transitory computer readable medium having embodied therein executable program code that when executed by a processor causes the processor to perform the above and/or other steps, operations, and the like. Still further illustrative embodiments comprise an apparatus with a processor and a memory configured to perform the above and/or other steps, operations, and the like. Some illustrative embodiments comprise a system configured to perform the above and/or other steps, operations, and the like. Further, some illustrative embodiments comprise an apparatus or a system comprising means for performing the above and/or other steps, operations, and the like.

Advantageously, some illustrative embodiments provide unified key management solutions for user equipment (UE), an access control and mobility function (ACMF), and an access user plane function (AUPF) to define user plane keys when there is no access stratum (AS) security context required in the network architecture. In some illustrative embodiments, unified key management solutions described herein are particularly well suited for implementation in a 6G architecture that implements a disaggregated radio access network implementation.

These and other features and advantages of embodiments described herein will become more apparent from the accompanying drawings and the following detailed description.

### BRIEF DESCRIPTION OF THE DRAWINGS

FIG. 1 illustrates a communication network environment with which one or more illustrative embodiments may be implemented.

FIG. 2 illustrates user equipment and entities with which one or more illustrative embodiments may be implemented.

FIG. 3 illustrates a network protocol stack with unified key management according to an illustrative embodiment.

FIGS. 4, 5A and 5B illustrate a unified key generation schema according to a first illustrative embodiment.

FIGS. 6A-6B illustrates a unified key generation procedure in a communication network environment according to a first illustrative embodiment.

FIG. 7 illustrates a unified key generation schema according to a second illustrative embodiment.

FIGS. 8A-8b illustrates a unified key generation procedure in a communication network environment according to a second illustrative embodiment.

### DETAILED DESCRIPTION

Embodiments will be illustrated herein in conjunction with example communication systems and associated techniques for security management in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3rd Generation Partnership Project (3GPP) system elements, such as 5G and 6G system elements, the disclosed embodiments can be adapted in a straightforward manner to a variety of other types of systems.

In accordance with illustrative embodiments, one or more 3GPP technical specifications (TS) and technical reports (TR) may provide further explanation of network elements/functions and/or operations that may interact with parts of the inventive solutions, for example, but not limited to, 3GPP TS 29.281 entitled, “Technical Specification Group Core Network and Terminals; General Packet Radio System (GPRS) Tunnelling Protocol User Plane (GTPv1-U)”, TS 29.244 entitled, “Technical Specification Group Core Network and Terminals; Interface between the Control Plane and the User Plane Nodes; Stage 3”, TS 33.220 entitled, “Technical Specification Group Services and System Aspects; Generic Authentication Architecture (GAA); Generic Bootstrapping Architecture (GBA)”, and TS 33.501 entitled, “Technical Specification Group Services and System Aspects; Security Architecture and Procedures for 5G System”, the disclosures of which are incorporated by reference herein in their entireties. Note that 3GPP TS/TR documents are non-limiting examples of communication network standards (e.g., specifications, procedures, reports, requirements, recommendations, and the like). However, while well-suited for 3GPP standards, embodiments are not necessarily intended to be limited to any particular standards.

It is to be understood that the terms 5G network, 6G network, and the like (e.g., 5G or 6G system, 5G or 6G communication system, 5G or 6G environment, 5G or 6G communication environment, etc.), in some illustrative embodiments, may be understood to comprise all or part of an access network and all or part of a core network. However, the terms 5G network or 6G network, and the like, may also occasionally be used interchangeably herein with the terms 5GC network or 6GC network, respectively, without any loss of generality.

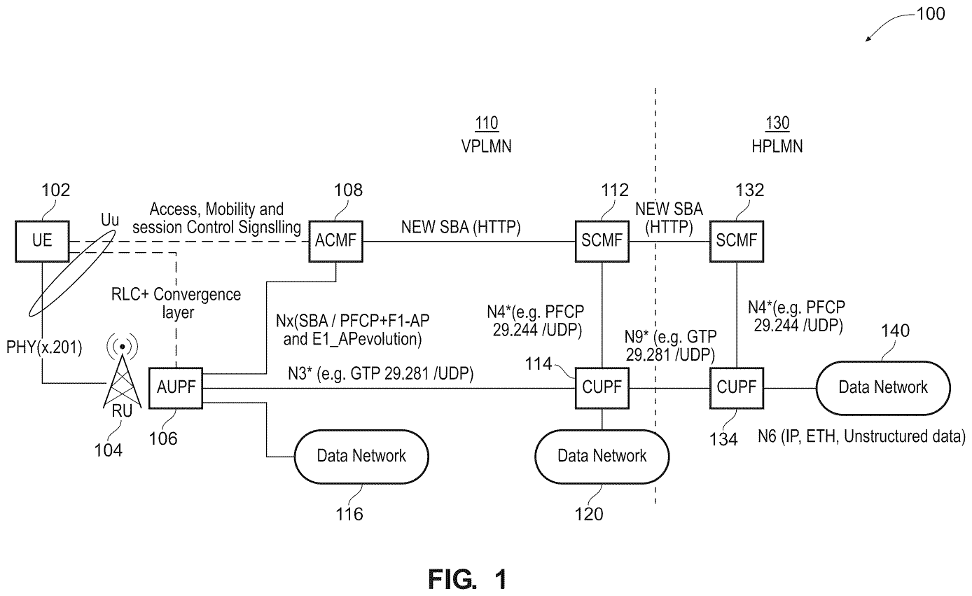

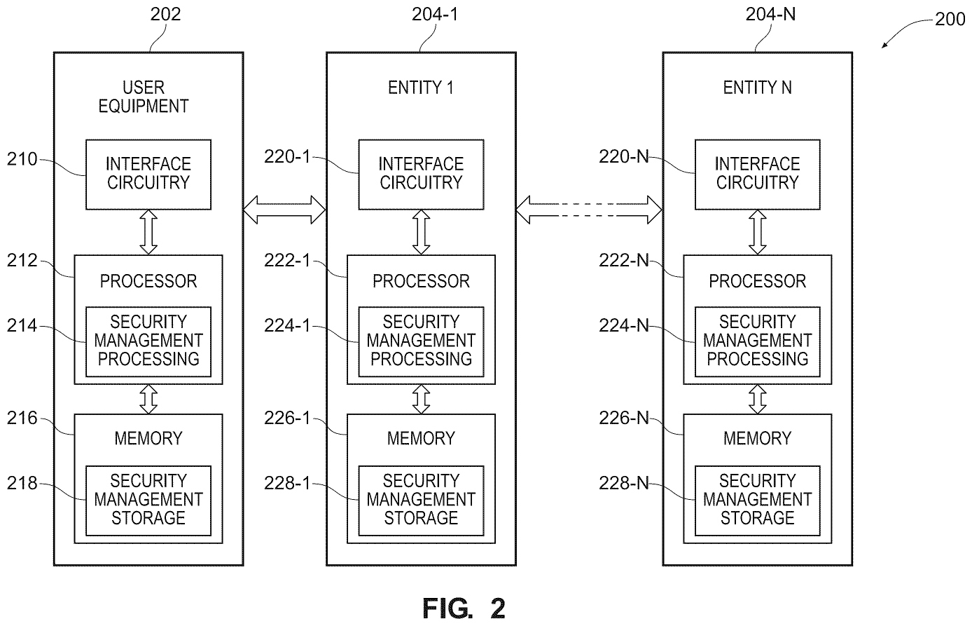

Prior to describing illustrative embodiments, a general description of certain main components of a 5G and/or 6G network will be described below in the context of FIGS. 1 and 2.

FIG. 1 shows a communication system 100 within which illustrative embodiments can be implemented. It is to be understood that the elements shown in communication system 100 are intended to represent some main functions provided within the system, e.g., access nodes, control plane functions, user plane functions, etc. As such, the blocks shown in FIG. 1 reference specific elements in 5G and/or 6G networks that provide some of these main functions. However, other network elements may be used to implement some or all of the main functions represented. Also, it is to be understood that not all functions of a 5G and/or 6G network are depicted in FIG. 1. Rather, at least some functions that facilitate an explanation of illustrative embodiments are represented. Subsequent figures may depict some additional elements/functions (i.e., network entities).

Accordingly, as shown, communication system 100 comprises user equipment (UE) 102. The UE 102 may be a mobile station, and such a mobile station may comprise, by way of example, a mobile telephone, a computer, an IoT device, or any other type of communication device. The term user equipment as used herein is therefore intended to be construed broadly, so as to encompass a variety of different types of mobile stations, subscriber stations or, more generally, communication devices, including examples such as a combination of a data card inserted in a laptop or other equipment such as a smart phone. Such communication devices are also intended to encompass devices commonly referred to as access terminals.

In one illustrative embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores a permanent subscription identifier and its related key, which are used to uniquely identify and authenticate subscribers to access networks. The ME is the user-independent part of the UE and contains terminal equipment (TE) functions and various mobile termination (MT) functions. Alternative illustrative embodiments may not use UICC-based authentication, e.g., a Non-Public (Private) Network (NPN).

Note that, in one example, the permanent subscription identifier is an International Mobile Subscriber Identity (IMSI) unique to the UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as Subscription Concealed Identifier (SUCI). Another example of a SUPI uses a Network Access Identifier (NAI). NAI is typically used for IoT communication.

As further depicted in FIG. 1, UE 102 communicates via an air interface with an access point 104. The access point 104 is illustratively part of a radio access network or RAN of the communication system 100. Such a radio access network may comprise, for example, a plurality of components which can, more generally, be considered radio access entities or access nodes.

One embodiment implements a disaggregated RAN architecture wherein the RAN is split into a radio unit (RU), a distributed unit (DU), and a centralized unit (CU) which can be further split into components, e.g., one CU for the control plane (CU-CP) and another CU for the user plane (CU-UP). A given RAN architecture may include a plurality of radio access entities such as multiple RUs, multiple DUs, multiple CU-CPs, and/or multiple CU-UPs. In general, for example, the RU manages radio frequency (RF) signals-converting them to digital signals- and performs signal processing so as to manage the interface between the antenna and the remainder of the RAN. In general, for example, the DU manages lower layers of a network protocol stack including real-time functions such as, e.g., radio link control (RLC), medium access control (MAC), and the physical (PHY) layer, thus performing data processing and scheduling closer to the antenna so as to enable low latency and efficient data transmission. In general, for example, the CU manages higher layers of the protocol stack including functions such as, e.g., radio resource management (RRM), mobility management (MM), and coordination of data flow and communication between the core network and the DU. Among other technical advantages, the disaggregated RAN architecture allows for flexibility and scalability in network deployment, e.g., network operators can deploy RUs, DUs, and CUs from different vendors enabling more customized and cost-effective networks.

As shown in FIG. 1, UE communicates with an RU that is part of or otherwise associated with the access point 104. However, it is to be understood that UE 102 may be configured to use one or more other types of access points (e.g., access functions, networks, etc.) to communicate with the core network. By way of example only, the access point 104 may be part of any 5G access network that uses a gNB, an untrusted non-3GPP access network that uses an Non-3GPP Interworking Function (N3IWF), a trusted non-3GPP network that uses a Trusted Non-3GPP Gateway Function (TNGF) or wireline access that uses a Wireline Access Gateway Function (W-AGF) or may correspond to a legacy access point (e.g., eNB). Furthermore, access point 104 may be a wireless local area network (WLAN) access point.

In a 5G network architecture, the access point 104 is typically operatively coupled to a network function referred to as an Access and Mobility Management Function (AMF/SEAF) which supports, inter alia, mobility management (MM) and security anchor (SEAF) functions. However, in a 6G network architecture, as shown in FIG. 1, certain radio access entities can be merged with other network functions. For example, the DU and the CU-UP of the disaggregated RAN architecture can be merged into an Access User Plane Function (AUPF) 106, while the CU-CP and AMF functionalities can be merged into an Access Control and Mobility Function (ACMF) 108.

As further shown in FIG. 1, AUPF 106 and ACMF 108 are part of a Visited Public Land Mobile Network (VPLMN) 110 (also referred to simply as a visited network or a serving network) along with other network functions including a Session Control and Management Function (SCMF) 112 and a Central User Plane Function (CUPF) 114. The SCMF 112 is operatively coupled to the ACMF 108 and has comparable functionalities as a Session Management Function (SMF) in a 5G network, while the CUPF 114 is operatively coupled to the AUPF 106 and has comparable functionalities as a User Plane Function (UPF) in a 5G network. Still further, as shown, AUPF 106 is operatively coupled to a data network 116, while CUPF 114 is operatively coupled to a data network 120.

Note that a UE is typically subscribed to what is referred to as a Home Public Land Mobile Network (HPLMN or home network) and, if the UE is roaming (not in the home network), it is typically connected with a VPLMN or serving network. The communication system 100 depicts a roaming scenario wherein a HPLMN 130 is the home network of UE 102, while VPLMN 110 is its (current) serving network. As such, UE 102 utilizes network functions of its HPLMN 130 via network functions of the VPLMN 110. More particularly, network functions of the VPLMN 110 can communicate with corresponding network functions of the HPLMN 130. For example, the HPLMN 130 includes an SCMF 132 which is operatively coupled to the SCMF 112 of the VPLMN 110, and a CUPF 134 which is operatively coupled to the CUPF 114 of the VPLMN 110. CUPF 134 is operatively coupled to a data network 140.

In some examples, data transmitted between AUPF 106, CUPF 114, and CUPF 134 can be protected using a GPRS Tunnelling Protocol (GTP) which is an Internet Protocol (IP) based communication protocol used to carry general packet radio service (GPRS) packets within the 5G and/or 6G network, e.g., see the above-referenced TS 29.281. Data networks 116, 120, and 140 can thus be private and/or public packet data networks.

Other network functions may include network functions that can act as service producers (NFp) and/or service consumers (NFc). Note that any network function can be a service producer for one service and a service consumer for another service. Further, when the service being provided includes data, the data-providing NFp is referred to as a data producer, while the data-requesting NFc is referred to as a data consumer. A data producer may also be an NF that generates data by modifying or otherwise processing data produced by another NF. Note that NFs may, more generally, be considered network entities whereby a network entity that consumes one or more of data and a service can be considered a consumer network entity and a network entity that produces one or more of data and a service can be considered a producer network entity.

It is to be appreciated that this particular arrangement of system elements is an example only, and other types and arrangements of additional or alternative elements can be used to implement a communication system in other embodiments. For example, in other embodiments, the communication system 100 may comprise other elements/functions not expressly shown herein.

Accordingly, the FIG. 1 arrangement is just one example configuration of a wireless cellular system, and numerous alternative configurations of system elements may be used. For example, although only single elements/functions are shown in the FIG. 1 embodiment, this is for simplicity and clarity of description only. A given alternative embodiment may of course include larger numbers of such system elements, as well as additional or alternative elements of a type commonly associated with conventional system implementations.

It is also to be noted that while FIG. 1 illustrates system elements as singular functional blocks, the various subnetworks that make up a 5G and/or 6G networks are partitioned into so-called network slices. Network slices (network partitions) are logical networks that provide specific network capabilities and network characteristics that can support a corresponding service type, optionally using network function virtualization (NFV) on a common physical infrastructure. With NFV, network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via access point 104.

FIG. 2 is a block diagram illustrating computing architectures for various participants in methodologies according to illustrative embodiments. More particularly, system 200 is shown comprising user equipment (UE) 202 and a plurality of entities 204-1, . . . , 204-N. For example, in illustrative embodiments and with reference back to FIG. 1, UE 202 can represent UE 102, while entities 204-1, . . . , 204-N can represent functions 106 and 108 (i.e., network entities such as, but not limited to, AUPF, ACMF, SCMF, and CUPF), as well as access point 104 (i.e., radio access entity such as, but not limited to, a RAN node or RU). It is to be appreciated that the UE 202 and entities 204-1, . . . , 204-N are configured to interact to provide security management and other techniques described herein.

The user equipment 202 comprises a processor 212 coupled to a memory 216 and interface circuitry 210. The processor 212 of the user equipment 202 includes a security management processing module 214 that may be implemented at least in part in the form of software executed by the processor. The security management processing module 214 performs security management described in conjunction with subsequent figures and otherwise herein. The memory 216 of the user equipment 202 includes a security management storage module 218 that stores data generated or otherwise used during security management operations.

Each of the entities (individually or collectively referred to herein as 204) comprises a processor 222 (222-1, . . . , 222-N) coupled to a memory 226 (226-1, . . . , 226-N) and interface circuitry 220 (220-1, . . . , 220-N). Each processor 222 of each entity 204 includes a security management processing module 224 (224-1, . . . , 224-N) that may be implemented at least in part in the form of software executed by the processor 222. The security management processing module 224 performs security management operations described in conjunction with subsequent figures and otherwise herein. Each memory 226 of each entity 204 includes a security management storage module 228 (228-1, . . . , 228-N) that stores data generated or otherwise used during security management operations.

The processors 212 and 222 may comprise, for example, microprocessors such as central processing units (CPUs), application-specific integrated circuits (ASICs), digital signal processors (DSPs) or other types of processing devices, as well as portions or combinations of such elements.

The memories 216 and 226 may be used to store one or more software programs that are executed by the respective processors 212 and 222 to implement at least a portion of the functionality described herein. For example, security management operations and other functionality as described in conjunction with subsequent figures and otherwise herein may be implemented in a straightforward manner using software code executed by processors 212 and 222.

A given one of the memories 216 and 226 may therefore be viewed as an example of what is more generally referred to herein as a computer program product or still more generally as a computer or processor readable (non-transitory or storage) medium that has executable program code embodied therein. Other examples of computer or processor readable media may include disks or other types of magnetic or optical media, in any combination. Illustrative embodiments can include articles of manufacture comprising such computer program products or other computer or processor readable media.

Further, the memories 216 and 226 may more particularly comprise, for example, electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 illustratively comprise transceivers or other communication hardware or firmware that allows the associated system elements to communicate with one another in the manner described herein.

It is apparent from FIG. 2 that user equipment 202 and plurality of entities 204 are configured for communication with each other as security management participants via their respective interface circuitries 210 and 220. This communication involves each participant sending data to and/or receiving data from one or more of the other participants. The term “data” as used herein is intended to be construed broadly, so as to encompass any type of information that may be sent between participants including, but not limited to, identity data, key pairs, key indicators, tokens, secrets, security management messages, registration request/response messages and data, request/response messages, authorization and/or authentication request/response messages and data, metadata, control data, audio, video, multimedia, consent data, other messages, etc.

It is to be appreciated that the particular arrangement of components shown in FIG. 2 is an example only, and numerous alternative configurations may be used in other embodiments. For example, any given network element/function and/or access point can be configured to incorporate additional or alternative components and to support other communication protocols.

Other system elements (network functions and other components not expressly shown in FIG. 1) may each be configured to include components such as a processor, memory and network interface. Also, entities such as third-party applications and network operators can participate in methodologies described herein via computing devices configured to include components such as a processor, memory and network interface. These elements and devices need not be implemented on separate stand-alone processing platforms, but could instead, for example, represent different functional portions of a single common processing platform.

More generally, FIG. 2 can be considered to represent processing devices configured to provide respective security management functionalities and operatively coupled to one another in a communication system. By way of example only, all or parts of each of UE 202 and the plurality of entities 204 (e.g., processor and memory) can be considered examples of means for performing one or more operations, one or more steps, one or more functions, one or more processes, etc. as described herein.

Given the above general description of relevant features of an illustrative 6G network, problems with existing key management approaches, and solutions proposed in accordance with illustrative embodiments, will now be described herein below.

In current 6G architecture proposals, it is assumed that after authentication, the ACMF will have K_{AMF} generated, and will then generate Non-Access Stratum (NAS) keys including Control Plane (CP) keys. The ACMF then needs to generate User Plane (UP) keys and provide them to the AUPF so that the AUPF can use the keys for encryption and integrity protection of UP data traffic. However, UP keys are currently generated based on K_{gNB}.

Moreover, in current 6G architecture proposals, NAS security alone is considered sufficient enough and thus AS (CP) layer security is not needed. However, if the AS layer security is disabled, then UP security will not work because UP keys are derived from K_{gNB}. Even if it is assumed that AS (CP) keys are generated but not used for AS (CP) security, then some disadvantages of this approach/assumption include: (i) K_{gNB} is used to derive further keys which have no purpose; and (ii) K_{gNB} needs to be generated at the UE and the core network—which will cause extra processing at both the UE and the core network and result in delaying other processing. Therefore, there is a need to provide improved key management methods and other functionalities—particularly for UP key generation.

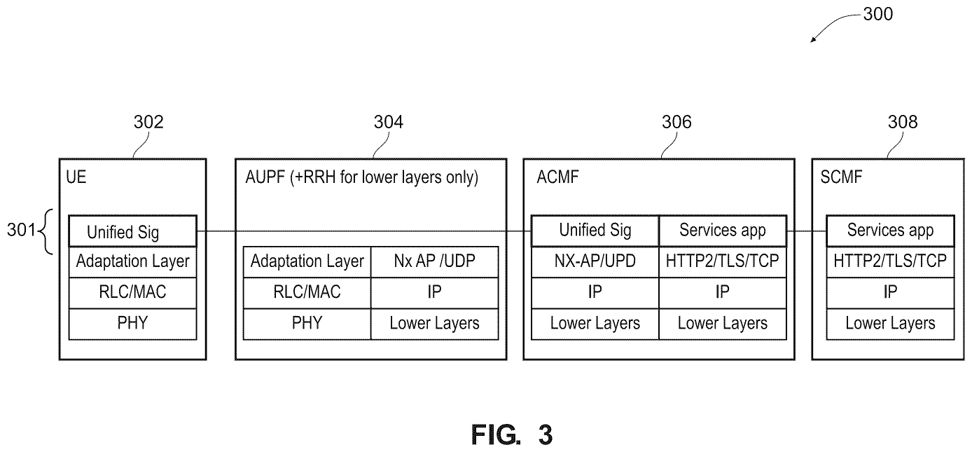

Illustrative embodiments overcome the above and other technical drawbacks by providing a unified security key generation approach across the UE, the AUPF, and the ACMF. FIG. 3 illustrates an end to end protocol stack 300 (UE to network) with unified signaling layer 301 for use in key management according to an illustrative embodiment. As generally illustrated, a UE 302, an AUPF 304, and an ACMF 306 coordinate, across the unified signaling layer 301, UP security key generation based on a single CP key. Such UP keys are usable, by way of example, for service application access via ACMF 306 and a SCMF 308. More particularly, given that current 6G architectures propose that no AS (CP) security is required, illustrative embodiments define new UP keys derived from a K_{ACMF} as will be further described below.

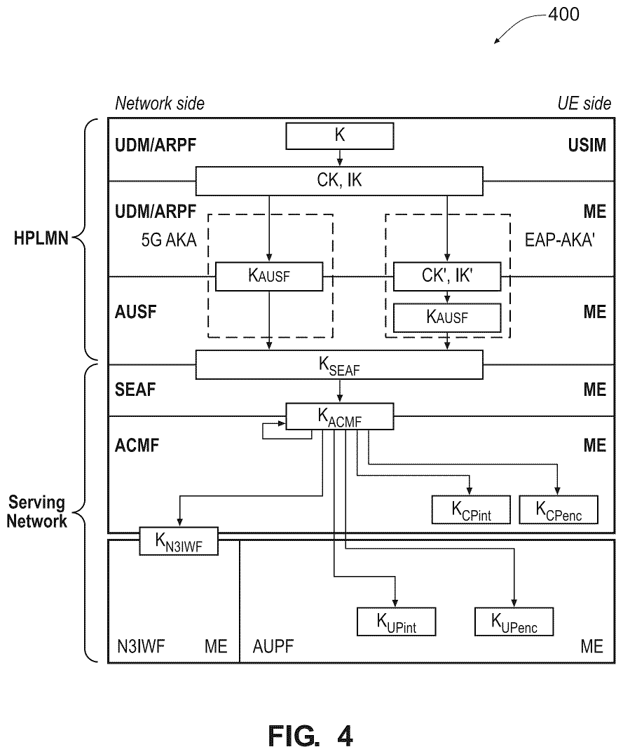

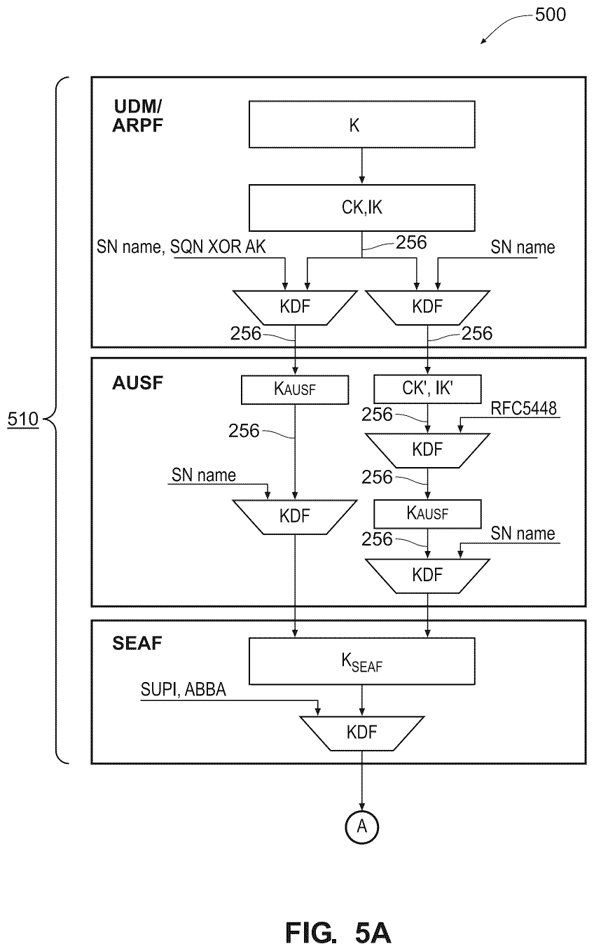

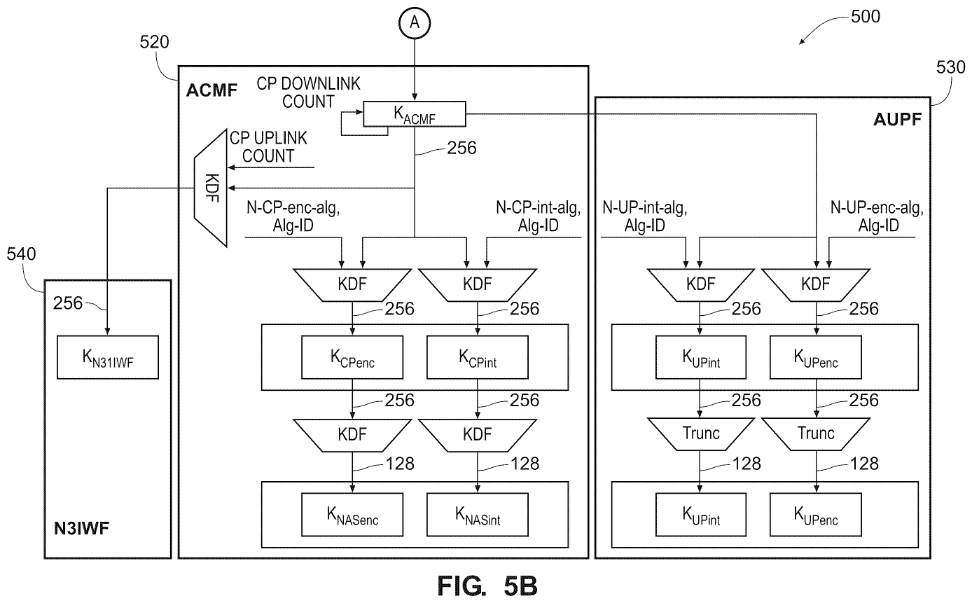

FIGS. 4, 5A and 5B illustrate a unified key generation schema according to a first illustrative embodiment. It is to be understood that a key generation schema 500 shown in FIGS. 5A-5B is a more detailed view of a key generation schema 400 shown in FIG. 4 (e.g., showing key derivation functions (KDFs) and their inputs/outputs at each stage of key generation). However, one of ordinary skill in the art will understand KDF processing in the unified key generation schema in a straightforward manner given the detailed description herein.

In one illustrative embodiment, key generation as per the above-referenced TS 33.220 can be implemented, wherein input parameters and their lengths are concatenated into a string S as follows:

1. The length of each input parameter measured in octets is encoded into a two octet-long string:

(a) Express the number of octets in input parameter Pi as a number k in the range [0, 65535].

(b) Li is then a 16-bit long encoding of the number k.

2. String S is constructed from n+1 input parameters as follows:

S=FC∥P0∥L0∥P1∥L1∥P2∥L2∥P3∥L3∥ . . . ∥Pn∥Ln
where:
FC is used to distinguish between different instances of an algorithm and is either a single octet or consists of two octets of the form FC1∥FC2 where FC1=0xFF and FC2 is a single octet,
P0 . . . Pn are the n+1 input parameter encodings, and
L0 . . . Ln are the two-octet representations of the length of the corresponding input parameter encodings P0 . . . Pn.

3. The final output, i.e., the derived key is equal to the KDF computed on the string S using the key, denoted Key. In TS 33.220, KDF is defined as follows:

derived key=HMAC-SHA-256(Key,S).

Additional or alternative key generation implementations can be used in other embodiments.

In one illustrative embodiment, K_{ACMF} (and K_{ACMF}′) generation can utilize a portion of the key generation schema from the above-referenced TS 33.501 for generation of K_{AMF} (K_{AMF}′) as shown in FIGS. 5A-5B. For example, as depicted in a portion 510 of key generation schema 500, a Unified Data Management (UDM) function with an Authentication Credential Repository and Processing Function (ARPF) utilizes a ciphering key (CK) and an integrity (protection) key (IK) to enable generation of K_{AUSF}, CK′ and IK′ (note that CK′ and IK′ are generated only in the case of EAP AKA′ being executed) for an Authentication Server Function (AUSF), which then enables generation of K_{SEAF} for a Security Anchor Function (SEAF). K_{SEAF} is then used with a SUPI (from UE) and an Anti-Bidding down Between Architectures (ABBA) parameter to generate K_{ACMF} (a single CP key) for an ACMF portion 520 of key generation schema 500, for an AUPF portion 530 of key generation schema 500, and for an N3IWF portion 540 of key generation schema 500.

In the ACMF portion 520, K_{ACMF} is used to generate K_{CPenc} and K_{CPint} which are then truncated to form K_{NASenc} and K_{NASint}, respectively.

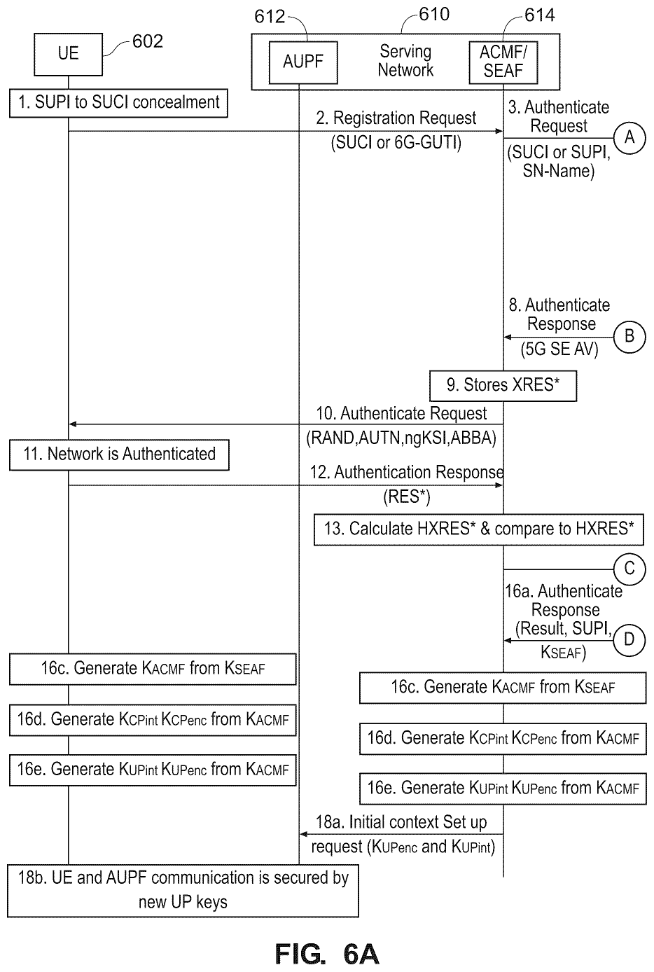

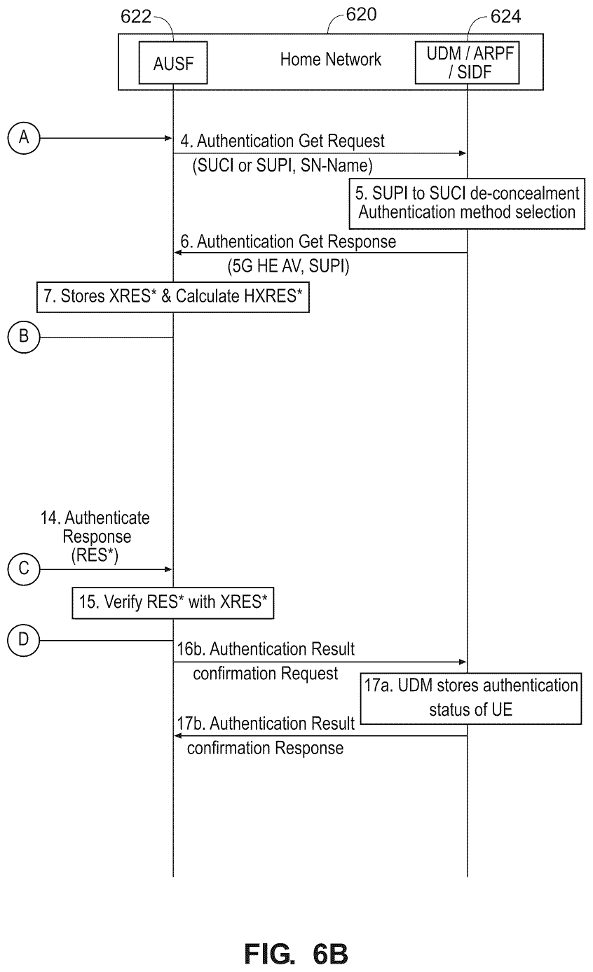

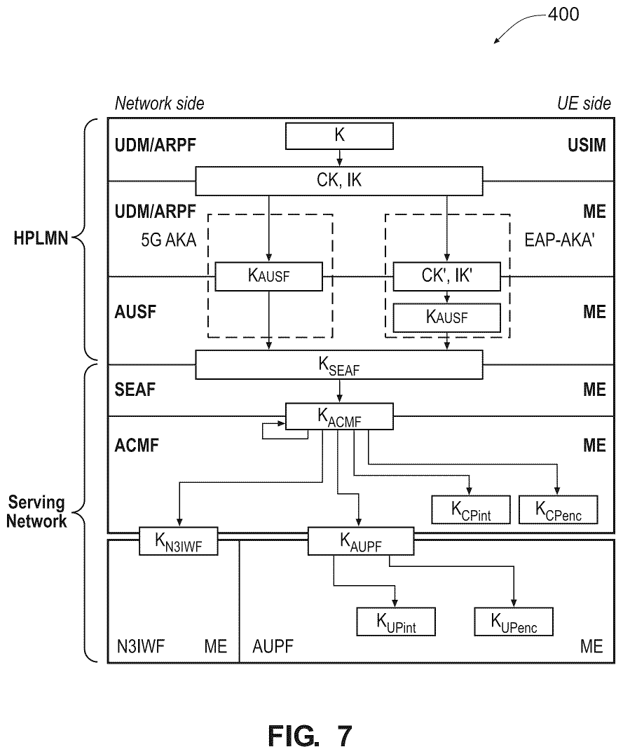

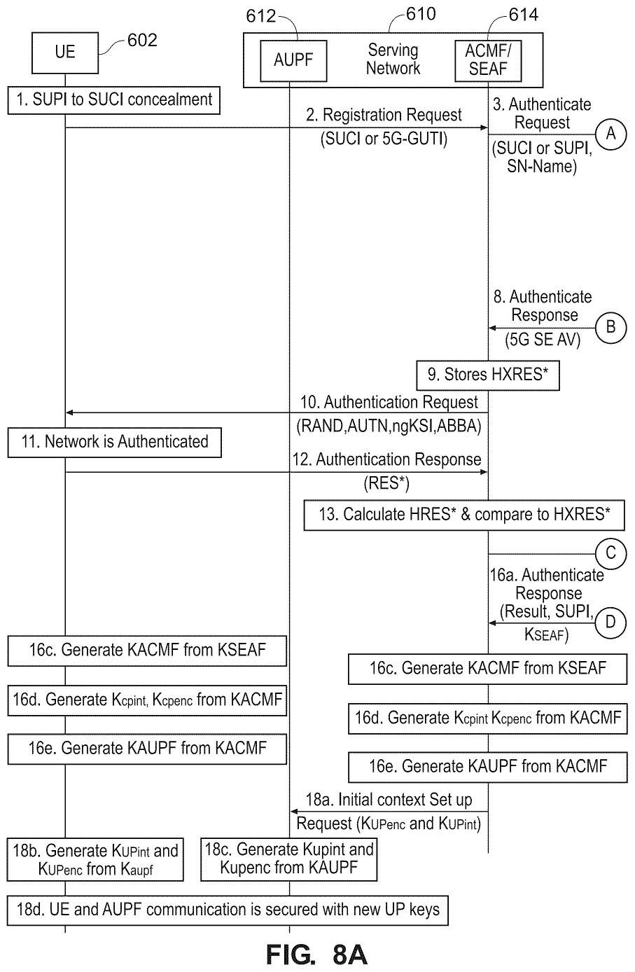

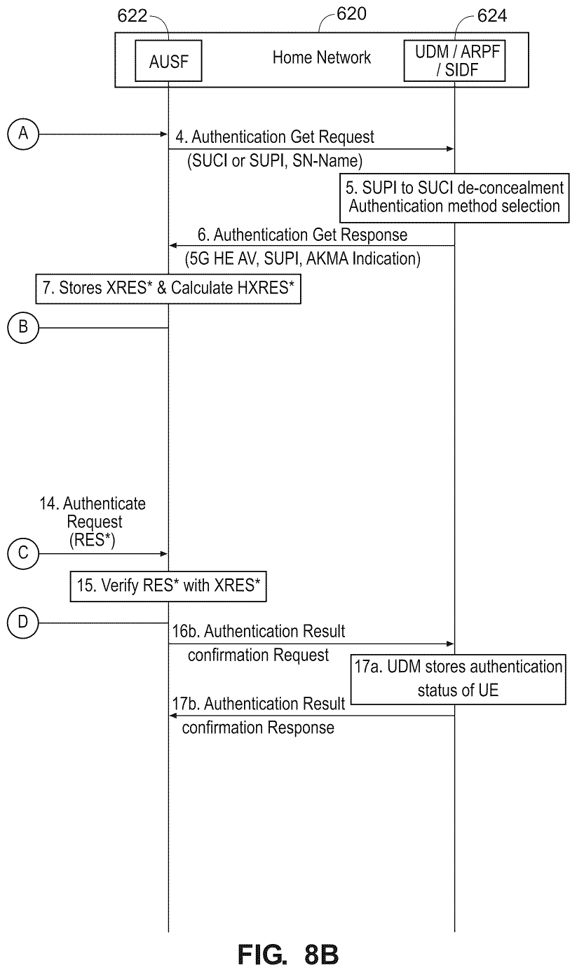

In the AUPF portion 530, K_{ACMF} is used with an identifier for the selected UP encryption algorithm (N-UP-enc-alg-ID) and an identifier for the selected UP integrity algorithm (N-UP-int-alg_ID) to generate untruncated K_{UPenc} and K_{UPint}—which are then truncated to form K_{UPenc} and K_{UPint}, respectively. In some embodiments (FIGS. 6A-6B), ACMF generates K_{UPenc} and K_{UPint} and provides the UP keys to AUPF, while in other embodiments (FIGS. 7, 8A and 8B), AUPF generates K_{UPenc} and K_{UPint}. While not expressly shown in FIGS. 5A-5B (but shown in FIG. 4), the UE independently generates (e.g., independent of the VPLMN) the same K_{ACMF} from K_{SEAF}, and then uses K_{ACMF} to independently generate the same K_{CPenc} and K_{CPint} and K_{UPenc} and K_{UPint}.

In the N3IWF portion 540, K_{ACMF} is used with a CP uplink count to generate K_{N3IWF}.

In accordance with one illustrative embodiment of unified key management, when deriving keys for CP integrity and CP encryption key or UP ciphering and integrity keys from K_{ACMF} in the ACMF and UE, the following parameters are used to form the string S:
FC=0x69
P0=algorithm type distinguisher
L0=length of algorithm type distinguisher (e.g., 0x00 0x01)
P1=algorithm identity
L1=length of algorithm identity (e.g., 0x00 0x01)

The algorithm type distinguisher is N-CP-enc-alg with a value of 0x01 for CP encryption algorithms and N-CP-int-alg with a value 0x02 for CP integrity protection algorithms. The algorithm type distinguisher is N-UP-enc-alg with a value 0x05 for UP encryption algorithms and N-UP-int-alg with a value of 0x06 for UP integrity protection algorithms.

In one illustrative embodiment, an algorithm identity is put in the four least significant bits of the octet. The two least significant bits of the four most significant bits are reserved for future use, and the two most significant bits of the most significant nibble are reserved for private use. The entire four most significant bits are set to all zeros.

FIGS. 6A-6B illustrates a procedure 600 using the key generation schema 500 (key generation schema 400) according to a first illustrative embodiment. As shown, procedure 600 involves a UE 602, a serving network (VPLMN) 610 with an AUPF 612 and an ACMF (with SEAF) 614, and a home network (HPLMN) 620 with an AUSF 622 and a UDM (with ARPF and a Subscriber Identity De-concealing Function (SIDF)) 624.

In step 1, UE 602 conceals its SUCI to generate a SUPI.

In step 2, UE 602 sends a registration request to ACMF 614 of serving network 610.

An authentication process for UE 602 is performed between serving network 610 and home network 620 as shown in steps 3-9, 14-16b, 17a and 17b, and between serving network 610 and UE 602 as shown in steps 10-13.

In steps 16c-16e, UE 602 and ACMF 614 independently each generate K_{ACMF} from K_{SEAF} and generate K_{CPenc} and K_{CPint} and K_{UPenc} and K_{UPint} from K_{ACMF} (e.g., as described above in the context of FIGS. 4 and 5).

In step 18a, ACMF 614 sends an initial security context set up request with K_{UPenc} and K_{UPint} to AUPF 612.

In step 18b, UE 602 and AUPF 612 establish a secure data communication channel using K_{UPenc} and K_{UPint}.

In an alternative embodiment, as illustratively depicted in a key generation schema 700 in FIG. 7 and a procedure 800 in FIGS. 8A-8B, CP keys (K_{CPenc} and K_{CPint}) and UP keys (K_{UPenc} and K_{UPint}) are generated separately. More particularly, following generation of K_{ACMF} as described above, a separate K_{AUPF} is generated from K_{ACMF}, as shown in FIG. 7. Then, as further shown in FIG. 7, K_{CPenc} and K_{CPint} are generated from K_{ACMF}, while K_{UPenc} and K_{UPint} are generated from K_{AUPF}.

When deriving the keys K_{AUPF} from K_{ACMF} and the uplink NAS COUNT in the UE and the ACMF, the following parameters are used to form the input S to the KDF:
FC=0x6E
P0=Uplink NAS COUNT
L0=length of uplink NAS COUNT (e.g., 0x00 0x04)
P1=Access type distinguisher
L1=length of Access type distinguisher (e.g., 0x00 0x01)

The values for the access type distinguisher are defined as follows. The values 0x00 and 0x03 to 0xf0 are reserved for future use, and the values 0xf1 to 0xff are reserved for private use. The access type distinguisher is set to the value for 3GPP (0x01) when deriving K_{AUPF}. The access type distinguisher is set to the value for non-3GPP (0x02) when deriving K_{N3IWF}.

The input key KEY is the 256-bit K_{ACMF}.

This function is applied when cryptographically protected 5G radio bearers are established and when a key change on-the-fly is performed.

When deriving keys for CP integrity and CP encryption from K_{ACMF} in the ACMF and the UE, the following parameters are used to form the string S:
FC=0x69
P0=algorithm type distinguisher
L0=length of algorithm type distinguisher (e.g., 0x00 0x01)
P1=algorithm identity
L1=length of algorithm identity (e.g., 0x00 0x01)

The algorithm type distinguisher is N-CP-enc-alg (value 0x01) for CP encryption algorithms and N-CP-int-alg for CP integrity protection algorithms (value 0x02).

The algorithm identity is put in the four least significant bits of the octet. The two least significant bits of the four most significant bits are reserved for future use, and the two most significant bits of the most significant nibble are reserved for private use. The entire four most significant bits are set to all zeros.

When deriving keys for UP ciphering and integrity keys from K_{AUPF} in the AUPF and the UE, the following parameters are used to form the string S:
FC=0x69
P0=algorithm type distinguisher
L0=length of algorithm type distinguisher (e.g., 0x00 0x01)
P1=algorithm identity
L1=length of algorithm identity (e.g., 0x00 0x01)

The algorithm type distinguisher is N-UP-enc-alg (value 0x01) for UP encryption algorithms and N-UP-int-alg (value 0x02) for UP integrity protection algorithms.

The algorithm identity is put in the four least significant bits of the octet. The two least significant bits of the four most significant bits are reserved for future use, and the two most significant bits of the most significant nibble are reserved for private use. The entire four most significant bits shall be set to all zeros.

Referring now to FIGS. 8-8B, procedure 800 uses the key generation schema 700 according to a second illustrative embodiment. As shown, procedure 800 involves a UE 802, a serving network (VPLMN) 810 with an AUPF 812 and an ACMF (with SEAF) 814, and a home network (HPLMN) 820 with an AUSF 822 and a UDM (with ARPF and a Subscriber Identity De-concealing Function (SIDF)) 824.

In step 1, UE 802 conceals its SUCI to generate a SUPI.

In step 2, UE 802 sends a registration request to ACMF 814 of serving network 810.

An authentication process for UE 802 is performed between serving network 810 and home network 820 as shown in steps 3-9, 14-16b, 17a and 17b, and between serving network 810 and UE 802 as shown in steps 10-13.

In steps 16c-16e, UE 802 and ACMF 814 independently each generate the same K_{ACMF} from K_{SEAF}, generate the same K_{CPenc} and K_{CPint} from K_{ACMF}, and generate the same K_{AUPF} from K_{ACMF} (e.g., as described above in the context of FIG. 7).

In step 18a, ACMF 814 sends an initial security context set up request with K_{AUPF} to AUPF 812.

In step 18b, UE 802 and AUPF 812 independently generate the same K_{UPenc} and K_{UPint} from K_{AUPF}.

In step 18c, UE 802 and AUPF 812 establish a secure data communication channel using K_{UPenc} and K_{UPint}.

Accordingly, in some embodiments, an apparatus comprises at least one processor and at least one memory storing instructions that, when executed by the at least one processor, cause the apparatus at least to: generate a first cryptographic value, independent of a generation of the same first cryptographic value at a first network entity of a first communication network, wherein the first network entity includes an access control and mobility function and the first cryptographic value is derived from a cryptographic value for a security anchor function; generate a set of one or more user plane cryptographic values from the first cryptographic value, independent of the generation of the same set of one or more user plane cryptographic values at the first network entity; and use the set of one or more user plane cryptographic values to securely communicate with a second network entity of the first communication network, wherein the second network entity includes an access user plane function.

In some further embodiments, the apparatus may further be caused to generate a set of one or more control plane cryptographic values from the first cryptographic value, independent of the generation of the same set of one or more control plane cryptographic values at the first network entity. The first cryptographic value may be a K_{ACMF}. The set of one or more user plane cryptographic values may include a user plane encryption key and a user plane integrity key. The set of one or more control plane cryptographic values may include a control plane encryption key and a control plane integrity key. Parameters used to generate one or more of the user plane encryption key, the user plane integrity key, the control plane encryption key and the control plane integrity key may include one or more of an algorithm type distinguisher, an algorithm identity, a length of the algorithm type distinguisher and a length of the algorithm identity.

In some other embodiments, the apparatus may further be caused to generate a set of one or more control plane cryptographic values from a second cryptographic value, independent of the generation of the same set of one or more control plane cryptographic values at the first network entity. The first cryptographic value may be derived from the second cryptographic value. The first cryptographic value may be a K_{AUPF} and the second cryptographic value may be a K_{ACMF}.

In some further embodiments, the at least one processor and at least one memory are part of user equipment.

In some embodiments, a method comprises: generating, by user equipment, a first cryptographic value, independent of a generation of the same first cryptographic value at a first network entity of a first communication network, wherein the first network entity includes an access control and mobility function and the first cryptographic value is derived from a cryptographic value for a security anchor function; generating, by the user equipment, a set of one or more user plane cryptographic values from the first cryptographic value, independent of the generation of the same set of one or more user plane cryptographic values at the first network entity; and using, by the user equipment, the set of one or more user plane cryptographic values to securely communicate with a second network entity of the first communication network, wherein the second network entity includes an access user plane function.

In some embodiments, an apparatus comprises at least one processor and at least one memory storing instructions that, when executed by the at least one processor, cause the apparatus at least to: generate a first cryptographic value, independent of a generation of the same first cryptographic value at user equipment connected to a first communication network, wherein the apparatus includes an access control and mobility function of the first communication network and the first cryptographic value is derived from a cryptographic value for a security anchor function; generate a set of one or more user plane cryptographic values from the first cryptographic value, independent of the generation of the same set of one or more user plane cryptographic values at the user equipment; and send the set of one or more user plane cryptographic values to an access user plane function of the first communication network to enable secure communication with the user equipment.

In some embodiments, a method comprises: generating, by a first network entity of a first communication network, a first cryptographic value, independent of a generation of the same first cryptographic value at user equipment connected to the first communication network, wherein the first network entity includes an access control and mobility function of the first communication network and the first cryptographic value is derived from a cryptographic value for a security anchor function; generating, by a first network entity, a set of one or more user plane cryptographic values from the first cryptographic value, independent of the generation of the same set of one or more user plane cryptographic values at the user equipment; and sending, by the first network entity, the set of one or more user plane cryptographic values to a second network entity of the first communication network which includes an access user plane function to enable secure communication with the user equipment.

In some embodiments, an apparatus comprises at least one processor and at least one memory storing instructions that, when executed by the at least one processor, cause the apparatus at least to: generate a first cryptographic value, independent of a generation of the same first cryptographic value at user equipment connected to a first communication network, wherein the apparatus includes an access control and mobility function of the first communication network and the first cryptographic value is derived from a cryptographic value for a security anchor function; generate a set of one or more control plane cryptographic values from the first cryptographic value, independent of the generation of the same set of one or more control plane cryptographic values at the user equipment; generate a second cryptographic value, independent of a generation of the same second cryptographic value at the user equipment, wherein the second cryptographic value is derived from the first cryptographic value; and send the second cryptographic value to an access user plane function of the first communication network to enable generation of set of one or more user plane cryptographic values for use in secure communication with the user equipment. For example, in some embodiments, the first cryptographic value is a key, K_{ACMF}, and the second cryptographic value is a key, K_{AUPF}.

In some embodiments, a method comprises: generating, by a first network entity of a first communication network, a first cryptographic value, independent of a generation of the same first cryptographic value at user equipment connected to the first communication network, wherein the first network entity includes an access control and mobility function of the first communication network and the first cryptographic value is derived from a cryptographic value for a security anchor function; generating, by a first network entity, a set of one or more control plane cryptographic values from the first cryptographic value, independent of the generation of the same set of one or more control plane cryptographic values at the user equipment; generating, by a first network entity, a second cryptographic value, independent of a generation of the same second cryptographic value at the user equipment, wherein the second cryptographic value is derived from the first cryptographic value; and sending, by a first network entity, the second cryptographic value to a second network entity of the first communication network which includes an access user plane function to enable generation of set of one or more user plane cryptographic values for use in secure communication with the user equipment.

In some embodiments, an apparatus comprises at least one processor and at least one memory storing instructions that, when executed by the at least one processor, cause the apparatus at least to: generate a set of one or more user plane keys independent of an access control and mobility function associated with a serving network to which the apparatus is connected; and establish, using the set of one or more user plane keys, a secure communication channel with an access user plane function of the serving network absent an access network security context.

In some further embodiments, parameters used for generating the set of one or more user plane keys may comprise one or more of an algorithm type distinguisher, an algorithm identity, a length of the algorithm type distinguisher, and a length of the algorithm identity. The set of one or more user plane keys may include a user plane encryption key and a user plane integrity key. The apparatus may further be caused to: encrypt user plane data using the user plane encryption key; and send the encrypted user plane data to the access user plane function. The apparatus may further be caused to: integrity protect user plane data using the user plane integrity key; and send the integrity protected user plane data to the access user plane function.

In some embodiments, a method comprising: generating, by user equipment, a set of one or more user plane keys independent of an access control and mobility function associated with a serving network to which the user equipment is connected; and establishing, by the user equipment, using the set of one or more user plane keys, a secure communication channel with an access user plane function of the serving network absent an access network security context.

In some embodiments, an apparatus comprises at least one processor and at least one memory storing instructions that, when executed by the at least one processor, cause the apparatus at least to: generate a set of one or more user plane keys independent of an access user plane function associated with a serving network to which the apparatus is connected; and establish, using the set of one or more user plane keys, a secure communication channel with an access user plane function of the serving network absent an access network security context.

In some embodiments, a method comprises: generating, by user equipment, a set of one or more user plane keys independent of an access user plane function associated with a serving network to which the user equipment is connected; and establishing, by the user equipment, using the set of one or more user plane keys, a secure communication channel with an access user plane function of the serving network absent an access network security context.

In some embodiments, an apparatus comprises at least one processor and at least one memory storing instructions that, when executed by the at least one processor, cause the apparatus at least to: receive a set of one or more user plane keys from an access control and mobility function in a serving network to which user equipment is connected; and establish, using the set of one or more user plane keys, a secure communication channel with the user equipment absent an access network security context. For example, in some embodiments, the at least one processor and the at least one memory are part of an access user plane function of the serving network.

In some embodiments, an apparatus comprises at least one processor and at least one memory storing instructions that, when executed by the at least one processor, cause the apparatus at least to: receive a key from an access control and mobility function in a serving network to which user equipment is connected; generate a set of one or more user plane keys based on the key; and establish, using the set of one or more user plane keys, a secure communication channel with the user equipment absent an access network security context. For example, in some embodiments, the at least one processor and the at least one memory are part of an access user plane function of the serving network.

It is to be appreciated that the particular processing operations and other system functionality described in conjunction with the diagrams described herein are presented by way of illustrative example only and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the various embodiments described herein are presented by way of illustrative example only and should not be construed as limiting the scope of the claims. For example, alternative embodiments can utilize different communication system configurations, user equipment configurations, base station configurations, authorization processes, messaging protocols and message formats than those described above in the context of the illustrative embodiments. These and numerous other alternative embodiments within the scope of the appended claims will be readily apparent to those skilled in the art.

What is claimed is:

1. A user equipment comprising:
at least one processor; and
at least one memory storing instructions that, when executed by the at least one processor, cause the user equipment at least to:
generate a first cryptographic value, independent of a generation of the same first cryptographic value at a first network entity of a first communication network, wherein the first network entity includes an access control and mobility function and the first cryptographic value is derived from a cryptographic value for a security anchor function;
generate a set of one or more user plane cryptographic values from the first cryptographic value, independent of the generation of the same set of one or more user plane cryptographic values at the first network entity; and
use the set of one or more user plane cryptographic values to securely communicate with a second network entity of the first communication network, wherein the second network entity includes an access user plane function.

2. The user equipment of claim 1, wherein the apparatus is further caused to generate a set of one or more control plane cryptographic values from the first cryptographic value, independent of the generation of the same set of one or more control plane cryptographic values at the first network entity.

3. The user equipment of claim 2, wherein the first cryptographic value is a K_{ACMF}.

4. The user equipment of claim 2, wherein the set of one or more user plane cryptographic values includes a user plane encryption key and a user plane integrity key.

5. The user equipment of claim 4, wherein the set of one or more control plane cryptographic values includes a control plane encryption key and a control plane integrity key.

6. The user equipment of claim 5, wherein parameters used to generate one or more of the user plane encryption key, the user plane integrity key, the control plane encryption key and the control plane integrity key includes one or more of an algorithm type distinguisher, an algorithm identity, a length of the algorithm type distinguisher and a length of the algorithm identity.

7. The user equipment of claim 1, wherein the apparatus is further caused to generate a set of one or more control plane cryptographic values from a second cryptographic value, independent of the generation of the same set of one or more control plane cryptographic values at the first network entity.

8. The user equipment of claim 7, wherein the first cryptographic value is derived from the second cryptographic value.

9. The user equipment of claim 7, wherein the first cryptographic value is a K_{AUPF} and the second cryptographic value is a K_{ACMF}.

10. An apparatus comprising:
at least one processor; and
at least one memory storing instructions of an access control and mobility function of a first communication network, wherein the instructions when executed by the at least one processor, cause the apparatus at least to:
generate a first cryptographic value, independent of a generation of the same first cryptographic value at user equipment connected to the first communication network, wherein the first cryptographic value is derived from a cryptographic value for a security anchor function;
generate a set of one or more user plane cryptographic values from the first cryptographic value, independent of the generation of the same set of one or more user plane cryptographic values at the user equipment; and
send the set of one or more user plane cryptographic values to an access user plane function of the first communication network to enable secure communication with the user equipment.

11. The apparatus of claim 10, wherein the apparatus is further caused to generate a set of one or more control plane cryptographic values from the first cryptographic value, independent of a generation of the same set of one or more control plane cryptographic values at the user equipment.

12. The apparatus of claim 11, wherein the first cryptographic value is a K_{ACMF}.

13. The apparatus of claim 11, wherein the set of one or more user plane cryptographic values includes a user plane encryption key and a user plane integrity key.

14. The apparatus of claim 13, wherein the set of one or more control plane cryptographic values includes a control plane encryption key and a control plane integrity key.

15. The apparatus of claim 14, wherein parameters used to generate one or more of the user plane encryption key, the user plane integrity key, the control plane encryption key and the control plane integrity key include one or more of an algorithm type distinguisher, an algorithm identity, a length of the algorithm type distinguisher, and a length of the algorithm identity.

16. The apparatus of claim 10, wherein the first cryptographic value is a key, K_{ACMF}.

17. An apparatus comprising:
at least one processor; and
at least one memory storing instructions of an access control and mobility function of a first communication network, wherein the instructions, when executed by the at least one processor, cause the apparatus at least to:
generate a first cryptographic value, independent of a generation of the same first cryptographic value at user equipment connected to the first communication network, wherein the first cryptographic value is derived from a cryptographic value for a security anchor function;
generate a set of one or more control plane cryptographic values from the first cryptographic value, independent of the generation of the same set of one or more control plane cryptographic values at the user equipment;
generate a second cryptographic value, independent of a generation of the same second cryptographic value at the user equipment, wherein the second cryptographic value is derived from the first cryptographic value; and
send the second cryptographic value to an access user plane function of the first communication network to enable generation of set of one or more user plane cryptographic values for use in secure communication with the user equipment.

18. The apparatus of claim 17, wherein the first cryptographic value is a key, K_{ACMF}, and the second cryptographic value is a key, K_{AUPF}.
